(19) United States
(12) Patent Application Publication
(10) Pub. No.: US 2014/0089288 A1
(43) Pub. Date: Mar. 27, 2014

(54) NETWORK CONTENT RATING

(71) Applicants: Farah Ali, Flower Mound, TX (US); Ayub S. Khan, Cupertino, CA (US); Azeez M. Chollampat, Palo Alto, CA (US); Damodaran Kesavath, East Palo Alto, CA (US)

(72) Inventors: Farah Ali, Flower Mound, TX (US); Ayub S. Khan, Cupertino, CA (US); Azeez M. Chollampat, Palo Alto, CA (US); Damodaran Kesavath, East Palo Alto, CA (US)

(21) Appl. No.: 13/627,892

(22) Filed: Sep. 26, 2012

(51) Int. Cl. G06F 17/30

(52) U.S. Cl. 707/709; 707/722; 707/706; 707/E17.014; 707/E17.108

(57) ABSTRACT

A system rates content on a network. A database stores ratings for the content. A rating service creates the ratings for the content. The rating service merges a first rating of the content with a second rating of the content to produce a third rating for the content. A user interface obtains search results from the rating service. When the search results include the content, the user interface displays the rating of the content along with the search results.

### BACKGROUND

The Internet provides a forum for making data available in diverse geographic locations. The world wide web (“WWW”) is a collection of various resources, available over the Internet, that are written in hypertext mark-up language (“HTML”).

There are various entities that rate web pages and that rate websites—i.e., collections of web pages—on the world wide web. The ratings are based on various criteria. Some ratings are based on predicted interest to user. Some ratings are based on estimated safety against malicious software residing on a site. Some ratings are based on the presence or predicted presence of offensive language, offensive images or other offensive materials. Some ratings are based on the existence of age appropriate or age inappropriate material. And so on.

### BRIEF DESCRIPTION OF DRAWINGS

FIG. 1 is a simplified block diagram of a system that rates content on a network in accordance with an implementation.

FIG. 2 is a simplified flowchart that shows the merge of ratings in accordance with an implementation.

FIG. 3 is a simplified flowchart that illustrates rating of content of a website in accordance with a full criteria in accordance with an implementation.

FIG. 4 is a simplified flowchart that illustrates rating similarity of content of a website in accordance with an implementation.

FIG. 5 is a simplified flowchart that illustrates determining when to reevaluate criteria in accordance with an implementation.

### DETAILED DESCRIPTION

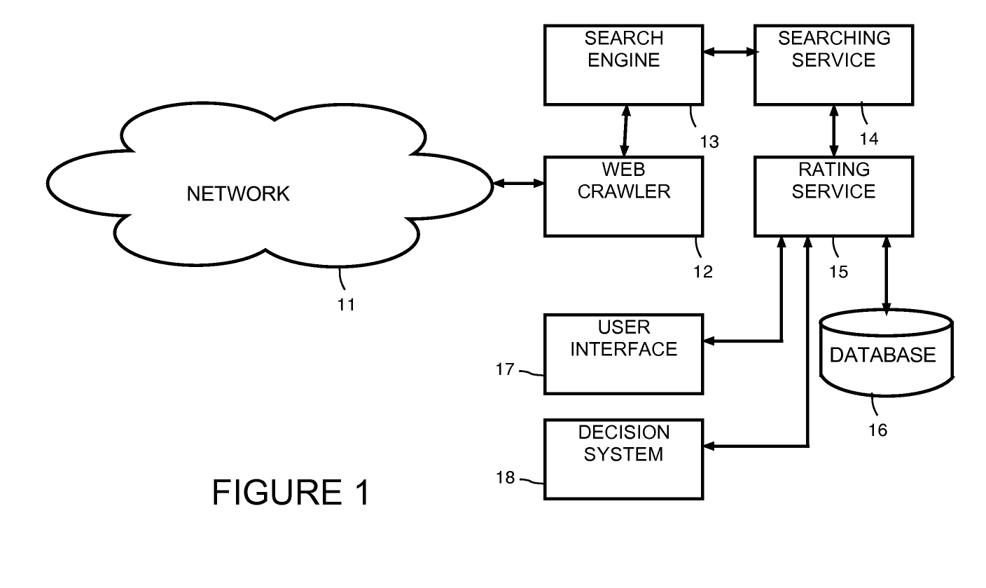

FIG. 1 is a simplified block diagram of a system that rates content on a network 11. For example network 11 is the Internet and the content being rated on network 11 are web pages or web sites located on the world wide web.

A web crawler 12 accesses content on network 11. For example, web crawler 12 can be any web crawler, such as the Nutch web crawler, or any other software program that browses the world wide web in a methodical and automated manner.

A search engine 13 searches content accessed by web crawler 12. Search engine 13 can be a search engine such as the SoIr search engine using the Lucene search engine library or any other search engine that searches documents for keywords and returns a list of documents that includes the key words.

Rating service 15, through searching service 14, specifies the searches to be performed by search engine 13. Ratings service 15 rates content within documents, portions of documents or groups of documents based on a rating criteria. For example, the rating criteria can be based on inclusion or exclusion of content—such as words, expressions, topics, images, video—that are deemed noteworthy by the rating service 15. The content may be deemed noteworthy for various reasons, which could include, for example, a judgment that the content is age appropriate or inappropriate, gender appropriate or inappropriate, demographic appropriate or inappropriate, offensive, pertinent to certain subject matter and so on.

The ratings for each document are stored in a database 16. When a user utilizing a user interface 17 performs a search, rating service 15 will present search results that include ratings for content stored in database 16. Rating service 15 will access the ratings stored in database 16 and use the ratings, for example, for filtering to determine which documents will be returned to the user, for ranking content returned as search results, and/or for displaying to the user the ratings to indicate to the user the rating of the content returned as search results.

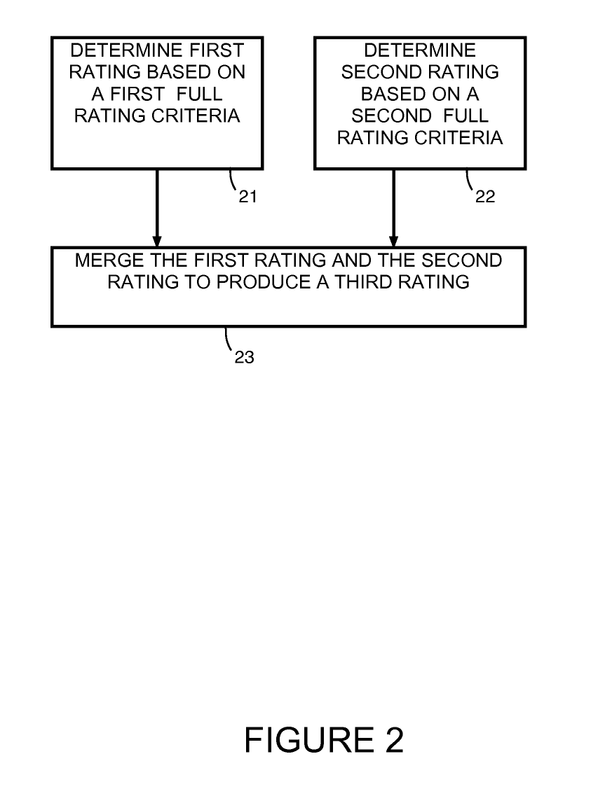

FIG. 2 is a simplified flowchart that shows the merging of ratings. In a block 21, a first rating for content, for example a web page or a web site, is produced based on a first full rating criteria.

In a block 22, a second rating for the same content, for example, the same web page or web site, is produced based on a second full rating criteria. In a block 23, the first rating and the second rating are merged to produce a third rating.

For example, the first rating is a standardized rating such as a motion picture association of America (MPAA) rating that rates content and the second rating is based on a separate criteria value rating content for dialogue (D), sexuality (S), language (L), violence (V) and fantasy violence (F) so that the rating consists of a five-tuple (D, S, L, V, F). In this example, the first rating and the second rating could be combined in a number of ways. For example, the combined rating could be a six-tuple (MPAA, D, S, L, V, F). Alternatively, for example, the combined rating could be used to change (i.e., by multiplication, addition or subtraction) one or more of the values in the five-tuple rating.

Alternatively, the MPAA rating and the 5-tuple rating could each be converted to a value that could be combined. For example, the MPAA as an integer assigned to each rating so that G=1, PG=2, PG-13=3, R=4 and NC-17=5. Also, for example, each of the tuples in five-tuple (D, S, L, V, F) has a value from 1 to 5 where 1 is deemed most appropriate for all audiences, and 5 is deemed most likely to be inappropriate for an audience. In this case a combined rating (CR) might be calculated, for example, as set out in the equation below:

CR=MPAA+(D+S+L+V+F)/5

The MPAA rating and the 5-tuple rating are only exemplary. Other rating criteria can be used. For example, to produce a full rating criteria, a rating service could be used to generate digital certificates that capture a rating specific to a set of criteria. A rated website may display that level of rating (in the issued certificate) in the form of a rating emblem that displays the rating information. For example a website may be issued a rating of 5.0 (out of 10) for “Authentic Content”, calculated as further described below. Alternatively, website content can be rated for authenticity by comparing its content with that of Wikipedia or another Wiki website as further described below.

Use of a rating service allows custom rating criteria to be defined using a ratings definition language. An example of such as custom rating for rating job-hunting websites could, for example, be based on the criteria set out in Table 1 below:

TABLE 1

(a) Total number of unique advertised jobs (weight = 5)
(a) Total number of jobs based in Dallas, TX area (weight = 10)
(a) Number of expired postings <10% (weight = 10)
(a) Jobs that require skills in “Java programming” (weight = 8)

User specified rating criteria is a set of {<criteria>, <value range/threshold>, <weight>} tuples that can be used to evaluate website content or website operations. The rating criteria can, for example, include site operations data as well as static data contained on the website. What is meant by site operations data is data resulting from an operation performed on a website as opposed to static data which is contained on the website.

For example, on a jobs hunting website, examples of site operations data could be (1) how many postings are current; (2) how many postings require specific skills; and so on.

Custom rating criteria can also be generated, for example, by a user modifying another rating. For example, a user may choose to over-ride the “standard” MPAA definitions (for movie ratings) to provide a custom (e.g., stricter) set of criteria to evaluate movies, games and so on.

For example, rating data as well as metadata resides in database 16. The rating date is represented in a rating schema that enables the rating data to be exported outside of a database environment.

Exporting the rating data allows for the comparison of different ratings to be performed outside database 16, which is often faster than comparison of data within a database and it results in the use of fewer resources. Also, combining ratings to create a new rating outside of database 16 can be beneficial when a similar operation inside database 16 would consume expensive resources of database 16, such as processing resources and memory.

An example rating schema in the form of an extensible mark-up language (XML) file, is given in Table 2 below:

TABLE 2
<?xml version=“1.0” encoding=“UTF-8”?>
<Cawras>

<Version>1.0.0</Version>
<Ratings>

<Rating name=“TV-Y7-FV Rating”>

<System name=“TV Rating”>

<!-- media is a list of print, tv, screen, Braille, aural,

handheld, projection, tty or all -->

<media>TV</media>

</System>
<Audience label=“Y7”>

<Description>Audience for which the content is

appropriate for 7+</Description>

</Audience>
<Criterias>

<Criteria name=“FV”>

<Description>Fantasy violence</Description>
<!-- media is a list of print, tv, screen, Braille,

aural, handheld, projection, tty or all -->

<Criterion type=“Word” media=“tv”

weight=“90%”>Blood</Criterion>

<Criterion type=“Action” media=“tv”

weight=“80%”>Alcoholism</Criterion>

...

</Criteria>

</Criterias>
<Outcome threshold=“80%”>TV-Y7-FV</Outcome>

</Rating>
<Rating name=“TV-14 Rating”>

<System name=“TV Rating”>

<media>TV</media>

</System>
<Audience label=“Y14”>

<Description>Audience for which the content is

appropriate for 14+</Description>

</Audience>
<Criterias>

<Criteria name=“D”>

<Description>Dialogue</Description>
<Criterion type=“Expression” media=“all”

weight=“90%”>k*</Criterion>

</Criteria>
<Criteria name=“S”>

<Description>Sexuality</Description>
<Criterion type=“Expression” media=“all”

weight=“90%”>f*k</Criterion>

...

</Criteria>
<Criteria name=“L”>

<Description>Language</Description>
<Criterion type=“Expression” media=“all”

weight=“90%”>as*</Criterion>

...

</Criteria>
<Criteria name=“V”>

<Description>Violence</Description>
<Criterion type=“Expression” media=“all”

weight=“90%”>I want to k* you</Criterion>

</Criteria>

</Criterias>
<Outcome threshold=“80%”>TV-14</Outcome>

</Rating>

</Ratings>

</Cawras>

Another example of a custom rating criteria is a criteria specially designed for a youth under 7 years of age where fantasy violence has a filter to filter out age inappropriate words, pictures or action of alcoholism, blood spitting violence, explicit sexual contents, and so on.

Another example of custom rating criteria is a criteria rating a hotel based on user feedback, value of service and so on. In such a criteria a seven star hotel with a $1000 a night cost may be rated high than a 5 star hotel with a $500 cost based on value of service or user feedback.

The ability to merge ratings, as set out in FIG. 2, allows rating service 15 to rate the same digital content or site using multiple criteria. For example, as discussed above, a user may ask rating service 15 to rate a site concurrently (single pass) based on multiple separate criteria for example, the standard MPAA criteria plus another criteria such as authenticity.

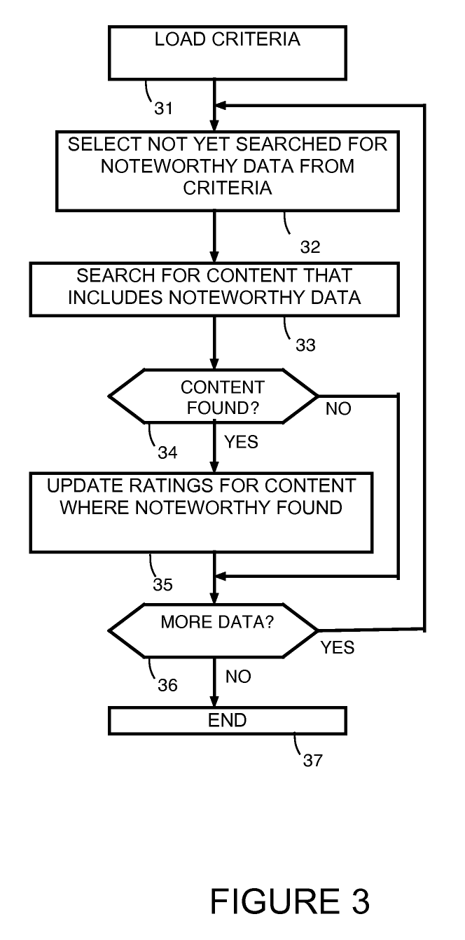

FIG. 3 is a flowchart that illustrates rating content based on a full criteria. In a block 31, the full criteria is loaded. The full criteria includes, for example, noteworthy data that, if found in content, affect the ratings.

In a block 32, not yet searched for noteworthy data from the loaded criteria is selected. Consider again the example of a criteria based on dialogue (D), sexuality (S), language (L), violence (V) and fantasy violence (F) so that the rating consists of a five-tuple (D, S, L, V, F). When determining the value for language (L), noteworthy data might, for example, be a list of offensive words or phrases that are used to determine a value for L. In this case, the noteworthy data selected in block 32 may be a single offensive word or a single offensive phrase that will be searched for.

In a block 33, content on network 11 is searched for the noteworthy data. For example, if network 11 is the Internet, every web page found by web crawler 12 can be searched for the noteworthy data.

In a block 34, it is determined whether and where the noteworthy data is found. For example, when network 11 is the Internet, every web page accessed by web crawler 12 can be searched for the noteworthy data.

If the noteworthy data is found, in a block 35 ratings for content where the noteworthy data is found is updated. For example, when network 11 is the Internet, the rating for every web page on which the noteworthy data is found is updated based on the presence of the noteworthy data on the web page. For example, using again the example of language (L), the frequency of the noteworthy data (e.g. offensive words per words in content) could be used when assigning a value from 1 to 5 for L to a web page. Alternatively, a single occurrence of the noteworthy data might be sufficient to assign a value of 5 to a web page. Alternatively some other way of assigning values may be used depending on implementation. The full rating for the web page can then be based, for example, on the current value of the five-tuple (D, S, L, V, F). Alternatively, a single value for a rating (R) can be calculated, for example, based on a formula such as the one set out below:

R=(D+S+L+V+F)/5

In a block 36, a check is made to see if there is additional noteworthy data in the full criteria. If so, in block 32 not yet searched noteworthy from the loaded criteria is selected.

If in block 36, it is determined that there is no additional noteworthy data in the full criteria that has not been searched for, in a block 37, this session of rating is completed.

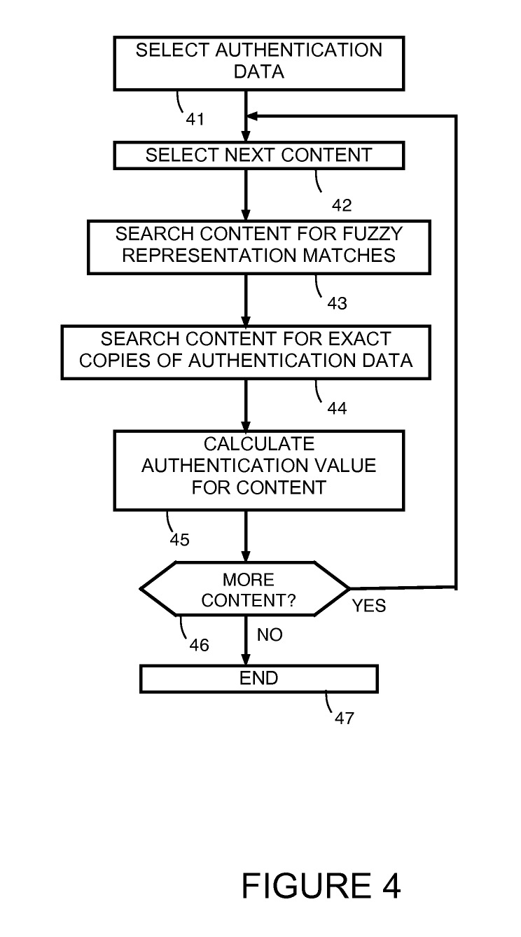

FIG. 4 is a simplified flowchart that illustrates rating similarity of content with other content located on network 11. For example, the other content is located on web pages or web sites on the Internet.

In a block 41, authentication data is selected. For example, the authentication data is string of data, such as a passage of text from a paper, a book or article. In a block 42, content on network 11 is selected.

In a block 43, the content on network 11 is searched to determine if one or more fuzzy representation matches of the authentication data exists within the content on network 11. What is meant by a fuzzy representation match of the authentication data is that the fundamental essence of the authentication data is present within specific content on network 11, whether or not the exact authentication data is present. That is, a fuzzy representation match of the authentication data can be either the exact representation of the authentication data or a representation of the authentication data that is not exact but is close enough that it is recognizable as having the fundamental essence of the authentication data.

An example of a fuzzy representation match might be a paraphrase of a passage out of a book where the basic meaning of the passage is communicated but where an exact word for word copy of the passage is not present. Another example of a fuzzy representation match is an exact word for word copy of the passage.

In a block 44, the content on network 11 is searched to determine if one or more exact representations of the authentication data exists within content. That is, in block 44, it is determined which of the fuzzy representation matches found in block 43 are also exact representations of the authentication data. For example, if the authentication data is a passage of text, an exact representation of the passage would include every word of the passage arranged in an exactly correct order.

In a block 45, an authentication value for the content is calculated. For example, the authentication value (A) is a ratio of the number of times the exact representation of the authentication data appears to the number of times a fuzzy representation match of the authentication data appears. For example, this ratio may be expressed as a percentage. For example, if the ratio is equal to 1 (or 100%) this indicates that every fuzzy representation match of the authentication data is also an exact representation of the authentication data. If the ratio is equal to 0.5 (or 50%), this indicates that half of the fuzzy representation matches of the authentication data are exact representations of the authentication data and half the fuzzy representation matches of the authentication data are representations of the authentication data that are not exact but are close enough that they are recognizable as having the fundamental essence of the authentication data while not being a word for word match of the authentication data. For example, when content at two locations on network 11 are compared, the content with the highest authentication value is regarded as being more similar than content with a lower authentication value.

Rating the similarity of content rate allows a determination of the degree to which digital content from different sources are related to each other. This has various applications. For example, similarity can be used to rate authenticity of works on a website as compared with “proof” content regarded as authentic, or at least a base line for comparison. For example, a CIA website might be regarded as an authentic baseline for information about a country, its economy, population, currency, cultivation, GDP and so on. Content from other websites can be compared content from the CIA website to suggest how authentic or reliable is the content on the other websites. Using the CIA website as a base line for comparison is an example. Any other website content deemed “authentic” or “reliable” can be used as a source of baseline content. For example, content from Wikipedia or another Wiki site could be used as a baseline for comparison.

Also, for example, an authentication value, as calculated above, can suggest the degree to which one source originates from another. Such an authentication value can, for example, be an aid in detecting plagiarism. For example, content such as an article or a paper could be tested for plagiarism by rating the similarity of authentication data from within the content to other content on network 11. A high level of similarity suggests the possibility of plagiarism, the possibility of which then could be further explored.

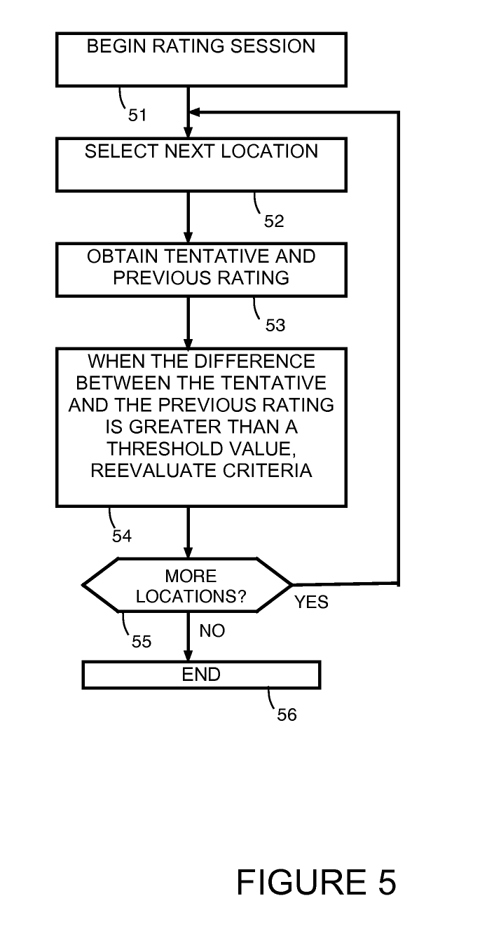

FIG. 5 is a simplified flowchart that illustrates how rating service 15 determines when to instigate reevaluation of the criteria used to rate content. In a block 51, a rating session begins. In a block 52, content from a next network location is selected. In a block 53, the rating criteria is run on the content to determine a new rating, which is a tentative rating. For example, the content can be rated based on criteria as described in the discussion herein pertaining to FIG. 3. Rating service 15 can access a previous rating for the content from database 16. That is, the previous rating for the content is a rating for the content that was generated previously by rating service 15 or by some other entity and is stored within database 16.

In a block 54, the criteria are reevaluated when a difference between the tentative rating and the previous rating is greater than a threshold value. For example, rating service 15 may instigate reevaluation of the criteria by notifying an administrator and requesting reevaluation of the criteria based on based on the difference between the tentative rating and the previous rating being greater than the threshold value.

Alternatively, rating service 15 may instigate reevaluation of the criteria by forwarding pertinent information about the previous rating and the tentative rating to a decision system 18, shown in FIG. 1, with preapproved rules and actions that can be utilized to automatically reevaluate the criteria without direct intervention from an administrator. Alternatively, decision system 18 can be utilized to automatically reevaluate the criteria, and if the results from the decision system recommend a change in the criteria, an administrator is notified and/or provided opportunity to approve or disapprove the recommended change in criteria.

In a block 55, a check is made to see if there are more locations to be evaluated. If so, in block 52, a next location is selected. If in block 55 it is determined there are no more locations to be evaluated, in a block 56 the rating session is complete.

The foregoing discussion discloses and describes merely exemplary methods and implementations. As will be understood by those familiar with the art, the disclosed subject matter may be embodied in other specific forms without departing from the spirit or characteristics thereof. Accordingly, the present disclosure is intended to be illustrative, but not limiting, of the scope of the invention, which is set forth in the following claims.

What is claimed is:

1. A system that rates content on a network, the system comprising:
a database that stores ratings for the content;
a rating service that creates the ratings for the content, the rating service merging a first rating of the content with a second rating of the content to produce a third rating for the content; and,
a user interface that obtains search results from the rating service and when the search results includes the content, displays the rating of the content along with the search results.

2. A system as in claim 1 wherein the system additionally comprises:
a crawler that retrieves data from the network in a methodical and automated manner;
a search engine that searches the data retrieved from the network, wherein the rating service utilizes the search engine when generating the first rating of the content.

3. A system as in claim 1 wherein the rating system rates the content based on dialogue (D), sexuality (S), language (L), violence (V) and fantasy violence (F).

4. A system as in claim 1 wherein the rating system rates the content to produce values for dialogue (D), sexuality (S), language (L), violence (V) and fantasy violence (F), wherein the first rating is calculated based on a sum of the values for dialogue (D), sexuality (S), language (L), violence (V) and fantasy violence (F).

5. A system as in claim 1 wherein the rating service uses the third rating to filter which content is returned to a user as search results.

6. A system as in claim 1 wherein the rating service uses the third rating to rank content that is returned to a user as search results.

7. A system that checks for similar content found on a network, the system comprising:
a search engine that searches within content on a network for authentication data, wherein the search engine recognizes an exact occurrence of the authentication data within the content and wherein the engine recognizes a fuzzy occurrence of the authentication data that is either an exact representation of the authentication data or a representation of the authentication data that is not exact but is close enough to be recognizable as having a fundamental essence of the authentication data; and,
a rating service that rates authenticity of the content based on a ratio of exact occurrences of the authentication data to fuzzy occurrences of the authentication data within the content.

8. A system as in claim 7 wherein the authentication is a passage of text.

9. A system as in claim 7 wherein the rating service ranks authenticity of locations on the network based on rated authenticity of the content at the locations.

10. A system that rates content found on a network, the system comprising:
a database that stores a previous rating for content;
a crawler that retrieves the content from the network; and,
a rating service that generates a new rating for the content based on the content as retrieved from the network, the rating service comparing the new rating with the previous rating and when a difference between the new rating and the previous rating is greater than a predetermined threshold, the rating service instigates a reevaluation of a criteria used to generate the new rating.

11. A system as in claim 10 additionally comprising:
a decision system with preapproved rules and actions that can be utilized to automatically reevaluate the criteria, wherein the rating service instigates reevaluation of the criteria by forwarding pertinent information about the new rating and the tentative rating to the decision system.

12. A system as in claim 10 wherein the rating service instigates reevaluation of the criteria by notifying an administrator.

13. A system as in claim 10 additionally comprising:
a decision system with preapproved rules and actions that can be utilized to automatically reevaluate the criteria, wherein the rating service instigates reevaluation of the criteria by forwarding pertinent information about the new rating and the tentative rating to the decision system, the decision system reevaluating the criteria and sending the reevaluated criteria to an administrator for approval.

14. A computer implemented method comprising:
creating a rating for content obtained from a network, including:
merging a first rating of the content with a second rating of the content to produce a third rating for the content, and
storing the third rating for the content in a database; and,
obtaining, by a user interface, search results for a search, including:
displaying the rating of the content, as obtained from the database, along with the search results when the search results include the content.

15. A computer implemented method as in claim 14 wherein creating a rating for the content additionally includes:
using a crawler to retrieve data from the from the network; and,
using a search engine to search the data retrieved from the network when generating the first rating of the content.

16. A method for determining similar content on a network, comprising:
using a search engine to search within the content on the network for authentication data, including:
recognizing exact occurrences of the authentication data within the content, and
recognizing fuzzy occurrences of the authentication data that are either exact representations of the authentication data or are representations of the authentication data that are not exact but are close enough to be recognizable as having a fundamental essence of the authentication data; and,
rating similarity of the content based on a ratio of exact occurrences of the authentication data to fuzzy occurrences of the authentication data within the content.

17. A method as in claim 16 additionally comprising:
ranking authenticity of locations on the network based on rated similarity of the content at the locations.

18. A computer implemented method for rating content found on a network, the method comprising:
using a crawler to automatically and systematically retrieve data from the network, the crawler retrieving the content from a location on the network;
generating a tentative rating for the content based on the content as retrieved from the network;
obtaining from a database a previous rating for the content;
comparing the tentative rating with the previous rating; and,
instigating a reevaluation of a criteria used to generate the new rating when a difference between the tentative rating and the previous rating is greater than a predetermined threshold.

19. A computer implemented method as in claim 18 wherein instigating the reevaluation includes:
forwarding pertinent information about the new rating and the tentative rating to a decision system with preapproved rules and actions that can be utilized to automatically reevaluate the criteria.

20. A computer implemented method as in claim 18 wherein instigating the reevaluation includes:
notifying an administrator.
